(19) United States
(12) Patent Application Publication
(10) Pub. No.: US 2012/0038486 A1
(43) Pub. Date: Feb. 16, 2012

(54) Fingerboard Latch Detection System

(76) Inventors: Duncan Sinclair, Houston, TX (US); Lance Suvans, Houston, TX (US)

(21) Appl. No.: 13/148,602

(22) PCT Filed: Jul. 18, 2011
(86) PCT No.: PCT/US11/44349

§ 371 Date: Aug. 9, 2011

Related U.S. Application Data
(60) Provisional application No. 61/365,432, filed on Jul. 19, 2010.

(51) Int. Cl. G08B 21/00

(52) U.S. Cl. 340/686.1

(57) ABSTRACT

A latch detection system is includes a fingerboard having a plurality of fingers for holding pipe, at least one latch displaced among the fingers for selecting securing the pipe among the fingers, a sensor operably connected to said latch to detect open and closed positions of the latch, and a control system operably connected to the latch to notify a user of the position of the latch. The latch detection system also includes a magnet embedded in the latch and a magnetic pickup sensor to detect the location of the latch. The sensor is a hall effect sensor. The control system can indicate to an operator that a latch has not been opened as expected and prevent subsequent latches form opening until error can be corrected.

### FIELD OF THE INVENTION

This invention relates to drilling pipe storage systems, and more particularly to an improved system for monitoring the opening of latches used on fingerboards

### BACKGROUND ART

On a drilling rig, drill pipe that is either removed from the hole or is prepared ready to go into the hole may be stored on the drill floor to provide fast access when making connections. This pipe may be stored with several sections screwed together called stands. Stands of pipe of approximately 90 feet in length are stored in a fingerboard, something positioned on a drilling floor of a drilling rig that stores stands of pipe in racks. It is called a fingerboard because it resemble a large hand with multiple fingers. To prevent the stands from tipping out of the fingers due to movement on the rig, latches are positioned on the fingers between the stands to secure the stands in position.

U.S. Pat. No. 7,083,007, incorporated herein by reference, describes a typical fingerboard having at least one fingerboard row for storing a plurality of threaded pipes. A plurality of latches are connected to the fingerboard rows for lockingly retaining the threaded pipes. Each of the latches is movable between a locked position and an unlocked position. A row controller is connected to each of the latches for individually and sequentially moving the latches between the locked and unlocked positions, wherein the row controller is manually operable from a location remote from the latches such that the latches are manually and remotely controlled.

When a drill floor operator wishes to remove a stand of pipe from the fingerboard they must first open the latch. This is usually accomplished by pressing a button which actuates a pneumatic cylinder causing the latch to open, thus allowing the stand of pipe to be removed from the finger.

Each time the operator pushes the release button, the next latch in turn is opened. No feedback system is present to confirm the latch opened correctly.

There have been several known instances where a latch failed to open due to being either faulty or held in place by the weight of the pipe. This causes the operator to push the button multiple times trying to open the latch. Rather than opening the latch that failed to open, this in fact causes subsequent latches to open. If and when the first latch finally opens, several stands of pipe may have been released, rather than just the one intended. Thus, subsequent stands may fall onto the drill floor, posing a serious risk of injury or death to personnel on the drill floor and/or damage to equipment. Additionally, there have been instances of automatic pipe handling tools damaging fingerboards by removing a stand of pipe while the latch was still engaged. This can cause downtime issues to the rig and lost revenue.

### SUMMARY OF THE INVENTION

In accordance with a preferred embodiment of the present invention, a latch detection system includes a fingerboard having a plurality of fingers for holding pipe, at least one latch displaced among the fingers for selectively securing said pipe among said fingers, a sensor operably connected to said latch to detect open and closed positions of the latch, and a control system operably connected to said latch to notify a user of said position of said latch.

In accordance with another prefered embodiment of the present invention, a latch detection system on a fingerboard having a plurality of fingers includes at least one latch displaced among the fingers for selecting securing a pipe stand among the fingers, a sensor strip operably connected adjacent the latch to detect open and closed positions of the latch, and a control system operably connected to said sensor strip to notify a user of the position of said latch. Further, the embodiment can include the ability of control system to disallow the opening of subsequent latches until an earlier latch is detected as open.

### BRIEF DESCRIPTION OF THE DRAWINGS

The novel features believed to be characteristic of the invention are set forth in the appended claims and claims yet to be filed. However, the invention itself, as well as a preferred mode of use and further objectives and advantages thereof, will best be understood by reference to the following detailed description when read in conjunction with the accompanying Figures, wherein:

FIGS. 1A and 1B illustrate the basic layout of a sensor and the magnetic actuator to be positioned at the end of a latch in accordance with the preferred embodiment of the present invention.

FIGS. 2A and 2B illustrate a sensor strip in accordance with a preferred embodiment of the present invention.

FIGS. 3A and 3B illustrate the finger interconnection showing several sensor strips and a finger controller in accordance with a preferred embodiment of the present invention.

FIG. 4 is a schematic diagram of the sensor of FIG. 1.

### DESCRIPTION OF THE INVENTION

This specification outlines the development of an apparatus and system used on new, and retrofitted on existing, fingerboards to enable the detection of the fingerboard latch position. This specification discloses an innovative system that will detect finger latch position, which will allow the control system to confirm if a latch is open and prevent a second latch from being opened inadvertently.

This invention consists of sensor strip detection system. Sensor strips will be mounted adjacent to the fingerboard latches so that when they are open, the system will detect the presence of the tip of the latch and inform the control system. If a latch fails to be confirmed “open” or “closed” within a preset time an audio and/or visual indication or will be raised and other latches prevented from opening. The basic detection system technology used is based on Rare Earth magnets and Hall Effect sensors. Each latch will have a magnet.

The system will consist of four to six sensor boards embedded in a urethane rubber encapsulated strip—creating a sensor strip—that will be mounted adjacent to the latch open or closed position. Multiple sensor strips can be connected together to provide a total of thirty two latch sensors per finger. Each finger will be equipped with a controller which will communicate with each sensor board and provide interface to the rig control system.

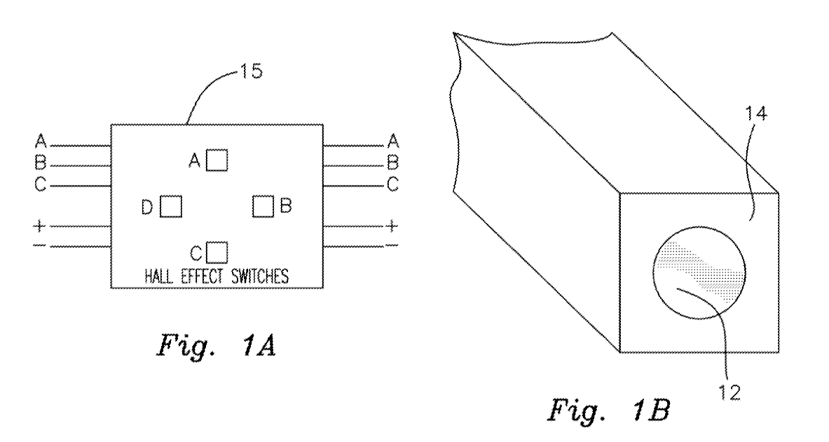

Turning first to FIG. 1, there is shown the basic layout of a sensor and the magnetic actuator to be positioned at the end of a latch in accordance with the preferred embodiment of the present invention. FIG. 1A illustrates the magnet 12 embedded in latch 14. In the preferred embodiment, magnet 12 is of the rear Earth kind, though any magnet suitable for the particular environment may be used. FIG. 1A illustrates a single circuit board 15 for detecting the position of one latch 14. Circuit board 15 includes four Hall Effect switches A, B, C, and D, though may include any number more or less, though at least one, as is appropriate for a particular application. Lines labeled A and B are typical communication lines as would be used with a standard RS485 bus and lines labeled + and—are power lines. It is intended that magnet 12 would be lined up so as to be able to magnetically engage with all four Hall Effect switches.

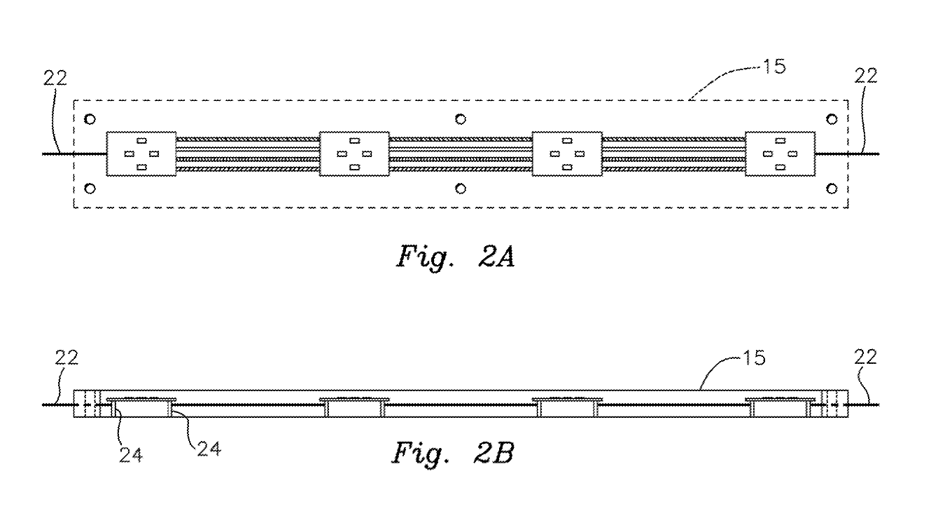

Turning next to FIG. 2, there is shown a sensor strip in accordance with a preferred embodiment of the present invention. FIG. 2A is a top view, whereas FIG. 2B is a side, cross-sectional view. In the preferred embodiment, four circuit boards 15 are connected one to the other to form a sensor strip. It will be appreciated that any number of circuit boards 15, more or less, may be connected to form a strip, as is appropriate for a particular application. In the illustrated embodiment, circuit boards 15 are spaced approximately 8 inches apart, center-to-center. At either end of the sensor strip, there is a connection cable for connecting one strip to another. The preferred connection cable is a standard four-core cable, readily available. As is illustrated at FIG. 2B, each circuit board 15 is mounted by standard mount 24.

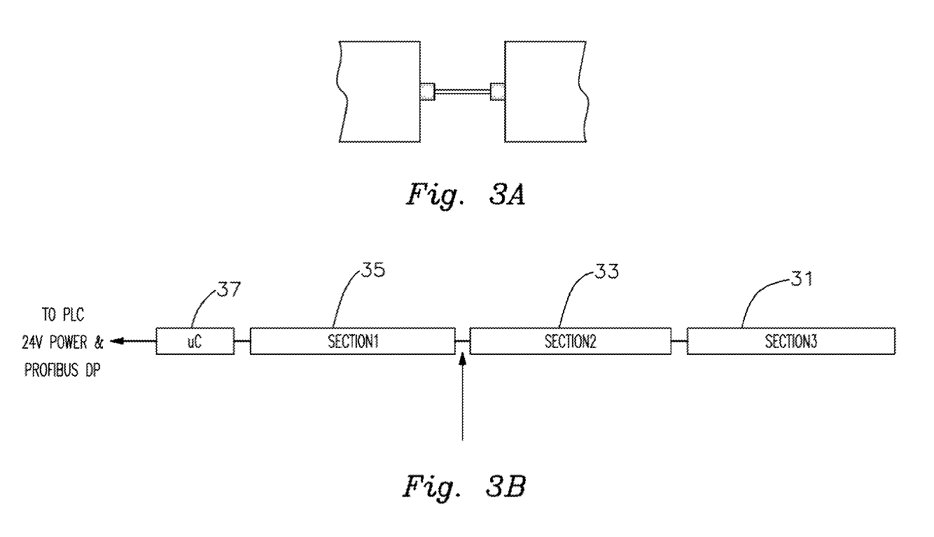

Turning next to FIG. 3, there is shown the finger interconnection showing several sensor strips of FIG. 2 and a finger controller in accordance with a preferred embodiment of the present invention. FIG. 3A shows the interconnection between sensor strips or sections, whereas FIG. 3B illustrates several sections 31, 33, and 35 connected one to the other, all connected to a micro-controller 37. In the illustrated embodiment, the connector of FIG. 3A is a standard cable connection between two strips. Other connectors may be used, as, for example, a center connection, connecting cable from each of the two strips. Other connections may also be employed. Further, FIG. 3B shows the use of a Profibus communication bus, though other standard buss connections may be employed such as a Mobus serial connection. Depending upon the communication bus used, minor but well know modifications are employed in the design.

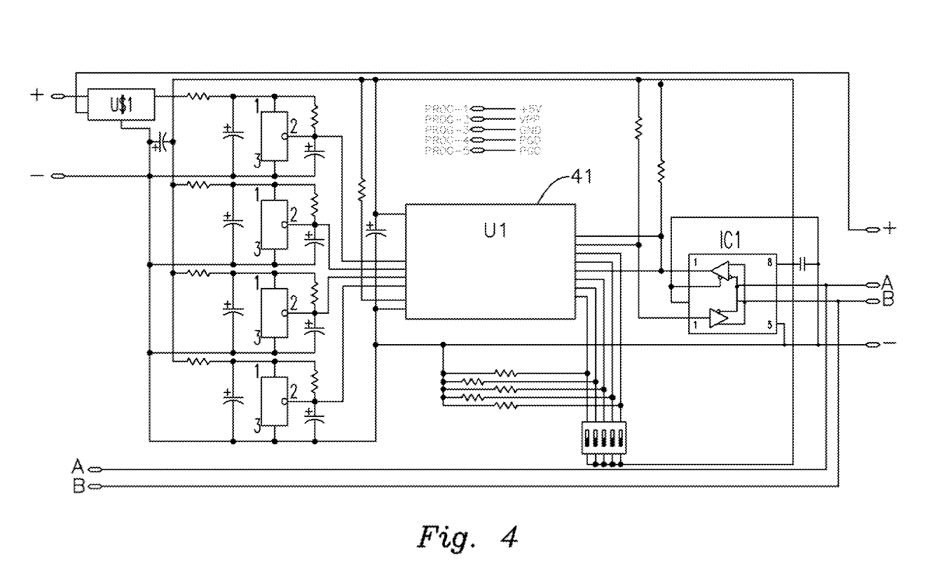

Turning next to FIG. 4, there is shown a schematic diagram of the circuit board 15 sensor of FIG. 1. Towards the left of FIG. 4 there is shown the 4 Hall Effect switches; Towards the center is micro-controller 41; Towards the right is the RS 485 line driver voltage level regulator circuitry. Micro-controller 41 can be programmed in a variety of ways. In the illustrated embodiment, micro-controller 41 is programed to detect the state—opened or closed—of each Hall Effect switch A, B,C and D, as well as the state of any two, any three and all four. In the event of any preset condition, micro-controller 41 is programmed to signal the latch opening system to provide an indication to the operator that a latch has not operated correctly and not allow subsequent latches to be opened. Such operator indication may be an audio signal, visual signal, or both.

While the this invention has been described in terms of various embodiments, it will be apparent to those of skill in the art that other variations can be applied to that described herein without departing from the concept, spirit and scope of the invention. All such similar substitutes and modifications apparent to those skilled in the art are deemed to be within the spirit, scope and concept of the invention as defined by the appended claims.

1. A latch detection system comprising:
a fingerboard having a plurality of fingers for holding pipe;
at least one latch displaced among said fingers for selecting securing said pipe among said fingers;
a sensor operably connected to said latch to detect open and closed positions of said latch; and
a control system operably connected to said latch to notify a user of said position of said latch.

2. A latch detection system as claimed in claim 1 further comprising a magnet embedded in said latch.

3. A latch detection system as claimed in claim 1 further comprising a magnetic pickup sensor to detect the location of the latch.

4. A latch detection system as claimed in claim 3 wherein said sensor is a hall effect sensor.

5. A latch detection system as claimed in claim 1 further comprising a plurality of sensors adjacent said latch.

6. A latch detection system as claimed in claim 5 further comprising an alarm operably connected to said sensors to detect inadvertent opening of a latch.

7. A latch detection system on a fingerboard having a plurality of fingers comprising
at least one latch displaced among said fingers for selecting securing a pipe stand among said fingers;
a sensor strip operably connected adjacent said latch to detect open and closed positions of said latch;
a control system operably connected to said sensor strip to notify a user of said position of said latch.

8. A latch detection system as claimed in claim 7 further comprising a magnet in said latch.

9. A latch detection system as claimed in claim 7 further comprising a hall effect sensor.

10. A latch detection system as claimed in claim 7 further comprising a urethane rubber encapsulated strip.
